(19) United States
(12) Patent Application Publication
(10) Pub. No.: US 2005/0254590 A1
(43) Pub. Date: Nov. 17, 2005

(54) Receiver, arrangement and method for decoding signal

(76) Inventors: Ilari Kukkula, Oulu (FI); Klaus Melakari, Oulu (FI)

Correspondence Address: Hollingsworth & Funk, LLC, Suite 125, 8009 34th Avenue South, Minneapolis, MN, 55425, US

(21) Appl. No.: 10/842,918

(22) Filed: May 11, 2004

(51) Int. Cl. H04L 5/12

(52) U.S. Cl. 375/267

(57) ABSTRACT

A solution for decoding a signal transmitted using space time block coding transmit diversity is provided. A given number of complex coded symbols are loaded to the input of a decoding processor. Complex instructions belonging to the instruction set of the decoding processor are performed on the complex coded symbols, the number of the instructions being at most equal to the number of coded symbols. Thus, decoded symbols are obtained as results of the instructions at the output of the decoding processor.

### FIELD

The invention relates to decoding a signal coded with a space time block coding.

### BACKGROUND

As is known in the art, the transmission path used for transmitting signals over data links causes interference to telecommunications. This occurs irrespective of the physical form of the transmission path, i.e. whether the transmission path is a radio connection, an optical fibre or a copper cable. Especially in radio communications, situations occur, in which the quality of the transmission path varies from one connection to another and also during a connection. A typical phenomenon is fading occurring on the radio path and causing changes to a transmission channel. Other concurrent connections may also cause interference, which may vary as a function of time and place.

In a typical radio communications environment, signals between a transmitter and a receiver propagate over several paths. Such multi-path propagation is mainly caused by a signal being reflected from surrounding surfaces. Signals that have propagated along different paths arrive at the receiver at different times owing to different propagation time delays.

In designing transmission methods these impairments are taken into account. The signals to be transmitted are coded prior the transmission. Diversity may be used in the transmitter and in the receiver.

Antenna diversity employs more than one antenna for transmitting and/or receiving a signal. Thus, the signal components that have multi-path-propagated through different channels will probably not be interfered with by a simultaneous fade. The receiver combines the signals for instance by means of MLSE (maximum likelihood sequence estimator) or MMSE (minimum mean square error) methods.

Cellular radio systems currently under development, such as UMTS, provide the possibility to use two transmit antennas. However, the use of even more antennas, for instance four antennas, in transmit diversity is also being developed.

An efficient method where diversity and coding are combined is Space-Time Transmit Diversity (STTD), which employs space time block coding and transmit diversity. STTD with encoding ratio 1 is applicable to two transmit antennas.

A receiver receiving a signal coded with space time block coding must naturally be able to decode the signal. In the design of modern receivers the size and the power consumption of the receiver is of great importance. Therefore in the design of receivers, also the size and efficiency of the decoder are minimised. The decoding process should take as few clock cycles as possible.

In prior art, a decoder of a space time block coded signal has been designed using fixed hardwired ASIC (Application Specific Integrated Circuit) logic. The decoder is thus realized with a discrete logic circuits embedded in an ASIC chip. Drawbacks of this solution are the space the logic on silicon and also relatively low efficiency.

### BRIEF DESCRIPTION OF THE INVENTION

An object of the invention is to provide an improved solution for decoding a space time block coded signal. According to an aspect of the invention, there is provided a method for decoding a signal transmitted using space time block coding transmit diversity, the method comprising: loading a given number of complex coded symbols to the input of a decoding processor; performing complex instructions belonging to the instruction set of the decoding processor on the complex coded symbols, the number of the instructions being at most equal to the number of coded symbols, thus obtaining decoded symbols as results of the instructions at the output of the decoding processor.

According to another aspect of the invention, there is provided an arrangement, arrangement to decode a signal coded with a space time block code, comprising: a first memory configured to store coded symbols, the symbols consisting of a real factor and an imaginary factor; a second memory configured to store decoded symbols; a processor connected to the first and second memory and configured to read a number of coded symbols from the memory; perform complex instructions belonging to the instruction set of the decoding processor on the complex coded symbols, the number of the instructions being at most equal to the total number of factors in the given number of coded symbols, thus obtaining decoded symbols as results of the instructions; and to store the decoded symbols into the second memory.

The solution of the invention provides several advantages. In an embodiment of the invention an application specific instruction set processor (ASIP) is utilized in decoding process. The instruction set of the processor is tailored for the decoding process. The instruction set comprises instructions to decode coded symbols in one or a few clock cycles. Thus, the decoder may be realized with as few clock cycles as possible. A flexible receiver structure leads to easier and faster designs of receivers. The invention also leads to lower power consumption of the receiver.

In an embodiment, the solution is utilized in a rake receiver. A rake receiver comprises several fingers which despread and demodulate received multipath signal components. The demodulated signal components are combined in a combiner realized with one or more processors with tailored instruction sets.

In an embodiment, the solution is utilized in an equalizer of a receiver. The equalizer processes the received signal to remove the effects of multipath fading and decodes the received signal.

In an embodiment, the processor is utilized also in other signal processing tasks comprising complex arithmetic. Thus silicon area can be utilized efficiently and manufacturing costs of the receiver can be reduced.

### LIST OF DRAWINGS

In the following, the invention will be described in greater detail with reference to the embodiments and the accompanying drawings, in which

FIGS. 1A and 1B show examples of a receiver where embodiments of the invention may be applied;

FIG. 2 illustrates an example of an arrangement of an embodiment;

FIG. 3 is a flowchart of an embodiment of the invention;

FIG. 4 is a flowchart of another embodiment of the invention and

FIGS. 5A and 5B illustrate examples of a decoding instructions.

### DESCRIPTION OF EMBODIMENTS

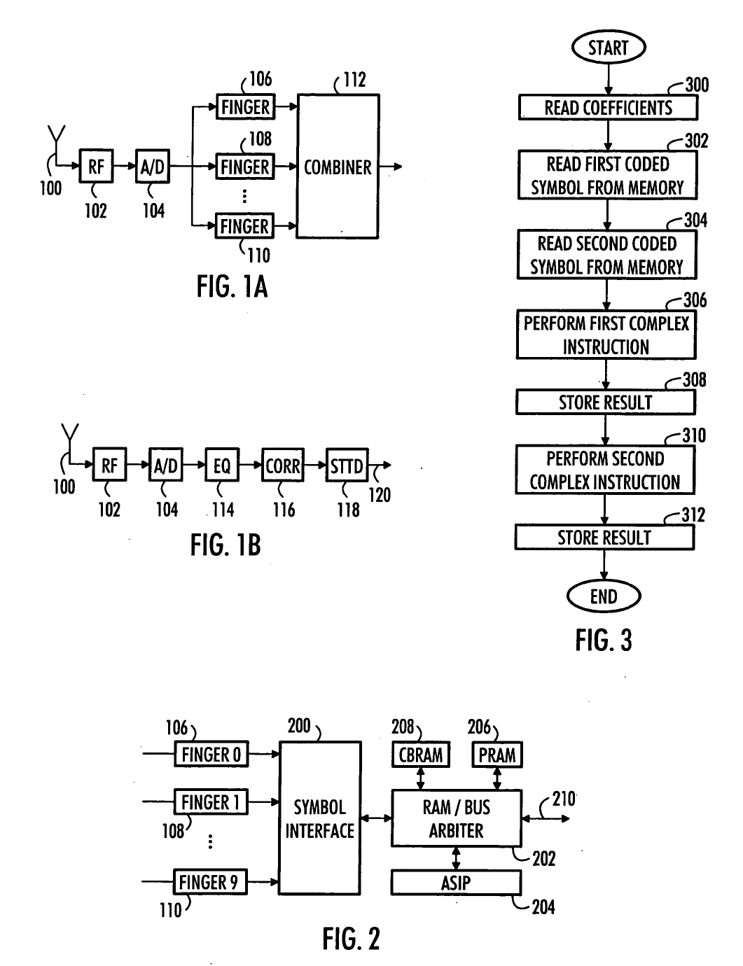

With reference to FIG. 1A, examine an example of a receiver in which embodiments of the invention can be applied. The figure illustrates the structure of a rake receiver. It is apparent for those skilled in the art that the invention is not limited to rake receivers of radio receivers but it can be applied in any receiver configured to decode a space time block coded signal.

The receiver of FIG. 1A comprises an antenna 100 with which a signal coded with a space time block code is received. The received signal is taken into a radio frequency part 102 where the signal is filtered and amplified in manners known for those skilled in the art. From the radio frequency part the signal is taken to a converter 104 where the signal is converted into a digital form. The converted signal is taken into a set of rake fingers 106 to 110. Each rake finger synchronises to a multipath signal component found in the received signal and despreads and demodulates it. The outputs of the rake fingers are taken into a combiner 112, where the demodulated signal components are decoded and combined. The decoded and combined signal is taken to other parts of the receiver not shown in FIG. 1A.

FIG. 1B illustrates another example of a receiver in which embodiments of the invention can be applied. The receiver of FIG. 1B comprises an antenna 100 with which a signal coded with a space time block code is received. The received signal is taken into a radio frequency part 102 where the signal is filtered and amplified in known ways. From the radio frequency part the signal is taken to a converter 104 where the signal is converted into a digital form. The converted signal is taken into an equalizer 114 which processes the received signal to remove the effects of multipath fading. From the equalizer the signal is taken into a correlator 116 and further to a STTD (Space-Time Transmit Diversity) decoder 118. The demodulated and decoded signal is taken to other parts of the receiver not shown in FIG. 1B.

Space-Time Transmit Diversity is an efficient method to combat fading. STTD employs two transmit antenna branches. The signal may be received with one antenna. In STTD coding, two complex symbols are input to a block encoder. Encoding process results in four complex valued symbols that are then transmitted from two different antenna branches.

Thus, assume that the two symbols to be transmitted are S1 and S2. The encoding is determined in its basic mode by a 2×2 matrix:

$$C ( S1 , S2 ) = [ \begin{matrix}S1 & S2 \\ - {S2}^{*} & {S1}^{*}\end{matrix} ] \qquad ( 1 )$$

where * denotes a complex conjugate. This matrix extends the encoding over two symbol periods. The pair S1, S2 is transmitted from the first antenna branch and the pair −S2*, S1* is transmitted simultaneously from the second antenna branch.

It can safely be assumed that the channel state is constant during the transmission of these symbols. The channel for the first transmission antenna branch may be denoted with H1 and the channel for the second transmission antenna branch with H2.

Thus, if the received symbols are denoted with R1 and R2, estimates E1, E2 for the transmitted symbols may be calculated as follows:
E1=R1*H1*+R2**H2 (2)
E2=−R1** H2+R2*H1*. (3)

FIG. 2 illustrates an example of decoding arrangement which can be applied, for example, in the receiver of FIG. 1. The arrangement comprises a set of rake fingers 106 to 110. Each rake finger synchronises to a multipath signal component found in the received signal and despreads and demodulates it. The outputs of the rake fingers are taken to a symbol interface 200. The symbol interface handles demultiplexing of symbols coming from the fingers. The interface also comprises memory addressing logic. The arrangement further comprises a Bus/Ram Arbiter 202. The arbiter contains logic for access arbitration of different memories. The arrangement further comprises an application-specific instruction processor (ASIP) 204. The processor performs the actual decoding. Software and other data for the processor are stored in memory 206.

The rake fingers 106 to 110 despread and demodulate different signal components and each finger output symbols R1, R2 which are stored in memory 208 by symbol interface 200 and arbiter 202. In an embodiment the memory 208 comprises a circular buffer for each rake finger. The decoded symbols may be stored in memory 206 before they are transferred onward 210 to other parts of the receiver not illustrated in FIG. 2. In practice, memories 206 and 208 may be implemented as one or more memory chips or units.

In an embodiment, the processor 204 is configured to read a number of coded symbols from the memory 208 and to perform complex instructions belonging to the instruction set of the decoding processor to the complex coded symbols, the number of the instructions being at most equal to the number of coded symbols, thus obtaining decoded symbols as results of the instructions. For example, in case of STTD employing two antenna branch diversity the number of symbols is two. In this case the number of the decoding instructions in the instruction set is either one or two. In an embodiment, each complex instruction gives as a result at least one complex decoded symbol. In the following example two instructions are utilized. The first instruction decodes the first symbol and the second instruction decodes the second symbol. In an embodiment, where one instruction is utilized, the single instruction decodes both symbols.

The flowchart of FIG. 3 illustrates an embodiment of the invention. In this embodiment, the instruction set of processor 204 comprises two complex instructions for the decoding of complex coded symbols R1, R2. Rake combining is not used. In step 300 channel coefficients H1, H2 are loaded from memory. In step 302 the first coded symbol R1 is read from memory. In step 304 the second coded symbol R2 is read from memory. In step 306 a first complex instruction is performed to calculate an estimate for the first decoded symbol. The instruction may perform the calculation according to formula (2). In step 308 the processor 204 stores the result of the instruction into memory 206. In step 310 a second complex instruction is performed to calculate an estimate for the second decoded symbol. The instruction may perform the calculation according to formula (3). In step 312 the processor 204 stores the result of the instruction into memory 206.

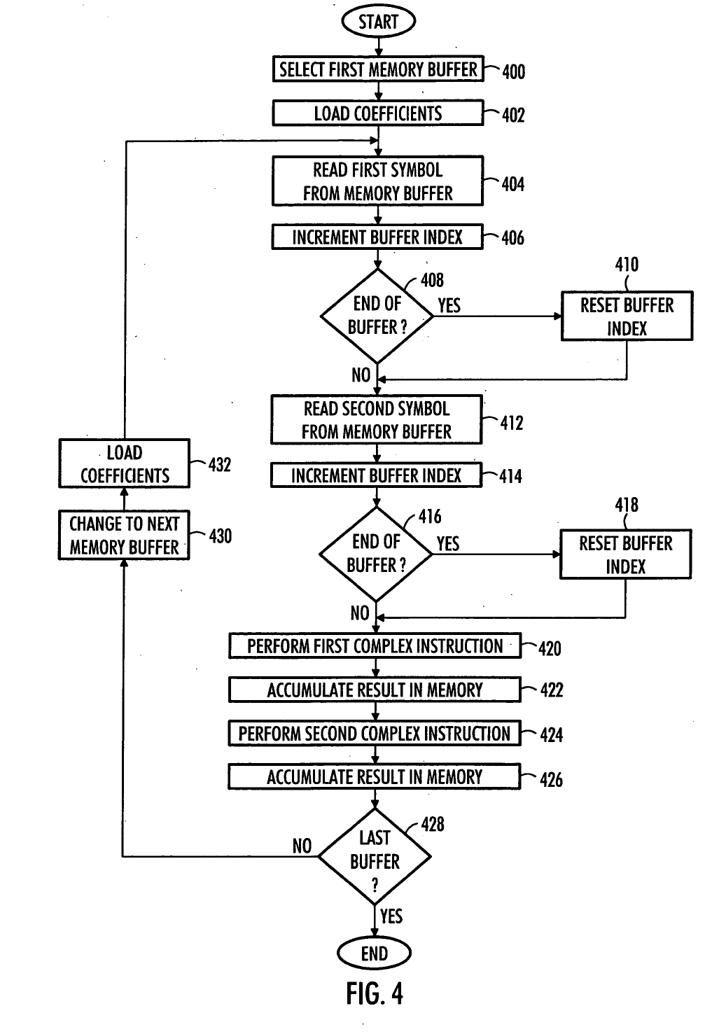

The flowchart of FIG. 4 illustrates another embodiment of the invention. In this embodiment complex coded symbols from rake fingers 106 to 110 are stored in circular buffers in memory 208. The processor performs also rake combining.

The circular buffers operate as data interface between rake fingers and a symbol interface and the processor. Each rake finger output is stored to a unique circular buffer from where data is read for further processing. The symbol interface and the processor take care of circular buffer memory allocations.

In step 400 a first circular memory buffer (corresponding to first rake finger) is selected. The index of the circular memory buffer is set to the beginning. In step 402 channel coefficients corresponding to the finger are loaded.

In step 404 the first coded symbol is read from the memory buffer. In step 406 a memory buffer index in incremented. In step 408 it is checked whether end of buffer has been reached. If this is the case, the buffer memory index is reset in step 410.

In step 412 a second coded symbol is read from the memory buffer. In step 414 a memory buffer index in incremented. In step 416 it is checked whether end of buffer has been reached. If this is the case, the buffer memory index is reset in step 418.

In step 420 a first complex instruction is performed to calculate an estimate for the first decoded symbol. The instruction may perform the calculation according to formula (2). In step 422 the processor 204 accumulates the result of the instruction in a given memory place E1 of the memory 206.

In step 424 a second complex instruction is performed to calculate an estimate for the second decoded symbol. The instruction may perform the calculation according to formula (3). In step 426 the processor 204 accumulates the result of the instruction in a given memory place E2 of the memory 206.

In step 428 it is checked whether all circular buffers have been gone through. In such a case the memory places E1 and E2 contain the cumulative decoded symbols from all rake fingers. Thus, the memory places contain combined energies of the symbols received using different rake fingers. If all fingers have not been calculated there are buffers that have not been calculated. In step 430 next circular buffer is selected. In step 432 respective channel coefficients are loaded. Then, the calculation continues from step 404.

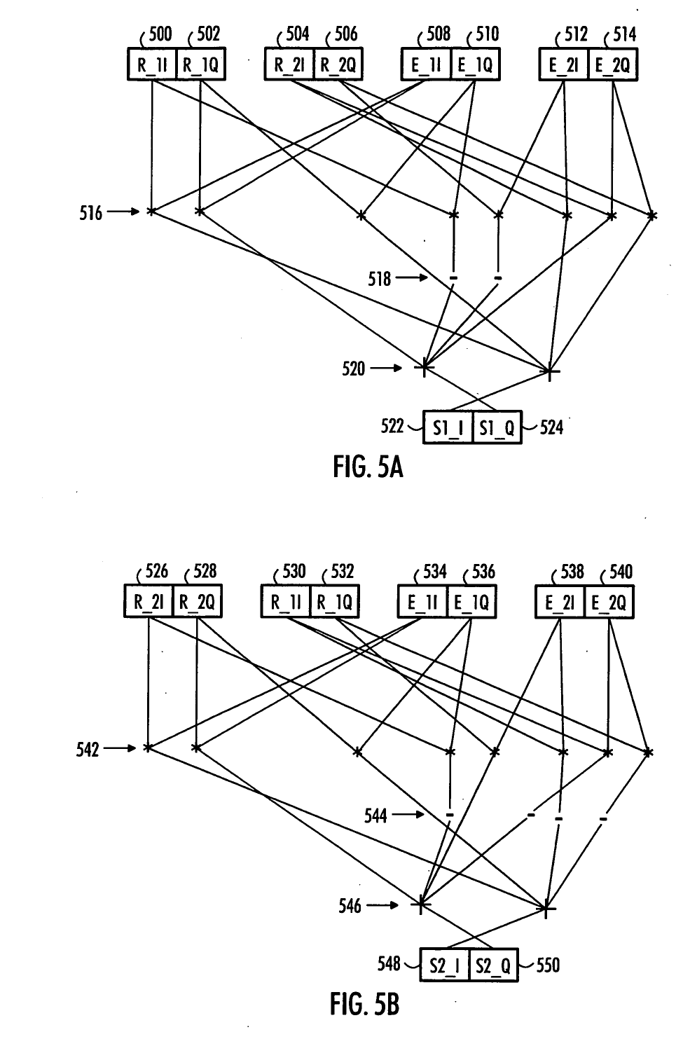

FIG. 5A illustrates an example of a decoding instruction according to equation (2) performed in arithmetic unit of the application-specific instruction processor 204. The input variables are in registers 500 to 514. They are loaded into the arithmetic unit in phases 300, 302 and 304 of the flowchart of FIG. 3 or in phases 402, 404 and 412 of the flowchart of FIG. 4. The input variables comprise the received symbols R1 and R2 and the respective channel coefficients H1 and H2. The instruction comprises multiplication and addition of these variables together with sign inversions.

In the following, complex symbols are presented as two-dimensional complex vectors I+jQ. Thus, in equations 2 and 3 following replacements are made:
R1=R_1I+j(R_1Q),
R2=R_2I+j(R_2Q),
H1=H_1I+j(H_1Q), and
H2=H_2I+j(H_2Q).

In the example of FIG. 5A, the register 500 comprises the real part R_1I of the received complex symbol R1. The register 502 comprises the complex part R_1Q of the received complex symbol R1. Respectively, the register 504 comprises real part R_2I of received complex symbol R2 and the register 506 comprises complex part R_2Q of the received complex symbol R2. The register 508 comprises real part H_1I of the complex channel coefficient H1 and the register 510 comprises complex part H_1Q of the complex channel coefficient H1. Respectively, the register 512 comprises real part H_2I of the complex channel coefficient H2 and the register 514 comprises the complex part H_2Q of complex channel coefficient H2.

In FIG. 5A, the asterisks 516 denote multiplications of the input variables, the minuses 518 denote sign conversions and pluses 520 denote additions. The result values of the instruction are stored in registers 522 and 524. The instruction can be presented as two equations:

$$\begin{matrix}E1\_I = R\_ 1 I * H\_ 1 I + R\_ 1 Q * H\_ 1 Q + \\ R\_ 2 I * H\_ 2 I + R\_ 2 Q * H\_ 2 Q & ( 4 ) \\ E1\_Q = - R\_ 1 I * H\_ 1 Q + R\_ 1 Q * H\_ 1 I + \\ R\_ 2 I * H\_ 2 Q - R\_ 2 Q * H\_ 2 I & ( 5 )\end{matrix}$$

where E1_I is the real part of decoded symbol estimate E1 and E1_Q is the complex part of decoded symbol estimate E1. E1_I is stored in register 522 and E1_Q is stored in register 524. E1_I and E1_Q are handled as two successive bits. Respectively in the transmitting end, where the transmitted symbol is S=S_I+j(S_Q), S_I and S_Q are handled as successive bits to be transmitted.

FIG. 5B illustrates an example of a decoding instruction according to equation (3) performed in arithmetic unit of the application specific instruction processor 204. The input variables are in registers 526 to 540. They are loaded into the arithmetic unit in phases 300, 302 and 304 of the flowchart of FIG. 3 or in phases 402, 404 and 412 of the flowchart of FIG. 4. The input variables comprise the received symbols R1 and R2 and the respective channel coefficients H1 and H2.

In the example of FIG. 5B, the register 526 comprises the real part R_2I of the received complex symbol R2. The register 528 comprises the complex part R_2Q of the received complex symbol R2. Respectively, the register 530 comprises the real part R_1I of the received complex symbol R1 and the register 532 comprises the complex part R_1Q of the received complex symbol R1. The register 534 comprises the real part H_1I of the complex channel coefficient H1 and the register 536 comprises the complex part H_1Q of the complex channel coefficient H1. Respectively, the register 538 comprises the real part H_2I of the complex channel coefficient H2 and the register 540 comprises the complex part H_2Q of the complex channel coefficient H2.

As in FIG. 5A, the asterisks 542 of FIG. 5B denote multiplications of the input variables, the minuses 544 denote sign conversions and pluses 546 denote additions. The result values of the instruction are stored in registers 548 and 550. The instruction of FIG. 5B can be presented as two equations:
E2_{—}I=R_2I*H_1I+R_2Q*H_1Q−R_1I*H_2I−R_1Q*H_2Q (6)
E2_{—}Q=−R_2I*H_1Q+R_2Q*H_1I−R_1I*H_2Q+R_1Q*H_2I (7)
where E2_I is the real part of the decoded symbol estimate E2 and E2_Q is the complex part of decoded symbol estimate E2. E2_I is stored in register 548 and E2_Q is stored in register 550. E2_I and E2_Q are handled as two successive bits.

In an embodiment, each of the above equations 4 to 7 are implemented as a separate instruction in the instruction set of an application specific instruction set processor (ASIP). Thus, there may be a separate instruction for each factor (I- and Q-factor) of a complex symbol.

In another embodiment, equations 4 and 5 are implemented as a single instruction and equation 6 and 7 are implemented as another instruction in the instruction set. Thus, the complex factors are decoded with the same instruction.

In an embodiment, the invention is realized as a computer program product encoding a computer program of instructions for executing a computer process for decoding a signal transmitted using space time block coding transmit diversity. In the embodiment, the process comprises loading a given number of complex coded symbols to the input of a decoding processor. The process further comprises performing complex instructions belonging to the instruction set of the decoding processor to the complex coded symbols, the number of the instructions being at most equal to the number of coded symbols, thus obtaining decoded symbols as results of the instructions at the output of the decoding processor.

Even though the invention is described above with reference to an example according to the accompanying drawings, it is clear that the invention is not restricted thereto but it can be modified in several ways within the scope of the appended claims.

1. A method for decoding a signal transmitted using space time block coding transmit diversity, the method comprising:
loading a given number of complex coded symbols to the input of a decoding processor;
performing complex instructions belonging to the instruction set of the decoding processor on the complex coded symbols, the number of the instructions being at most equal to the number of coded symbols, thus obtaining decoded symbols as results of the instructions at the output of the decoding processor.

2. A method for decoding a signal transmitted using space time block coding transmit diversity, the method comprising:
loading a given number of complex coded symbols to the input of a decoding processor, the symbols consisting of a real factor and an imaginary factor;
performing complex instructions belonging to the instruction set of the decoding processor on the given number of complex coded symbols, the number of the instructions being at most equal to the total number of factors in the given number of coded symbols, thus obtaining decoded symbols as results of the instructions at the output of the decoding processor.

3. The method of claim 1, further comprising:
receiving multipath propagated signal components in a receiver;
storing the coded symbols of the multipath propagated signal components in memory;
decoding the coded symbols in the decoding processor; and
combining the decoded symbols of the multipath propagated signal components corresponding to the same symbol with each other.

4. The method of claim 1, further comprising:
receiving multipath propagated signal components in a receiver;
storing the coded symbols of the multipath propagated signal components in memory;
decoding the coded symbols in the decoding processor; and
combining the decoded symbols of the multipath propagated signal components corresponding to the same symbol with each other.

5. A receiver, comprising:
a radiofrequency part configured to receive a signal transmitted using space time block coding transmit diversity;
a converter to convert the received signal into a digital form;
a demodulator to obtain coded symbols from the converted signal;
a memory to store the coded symbols;
a processor to read a number of coded symbols from the memory and to perform complex instructions belonging to the instruction set of the decoding processor on the complex coded symbols, the number of the instructions being at most equal to the number of coded symbols, thus obtaining decoded symbols as results of the instructions; and
a second memory to store the decoded symbols.

6. The receiver of claim 5, wherein
the received signal comprises multipath propagated signal components and the demodulator comprises more than one rake fingers to process the signal components.

7. The receiver of claim 5, wherein the demodulator is an equalizer.

8. The receiver of claim 6, wherein the processor is configured to decode the symbols of signal components and combine the decoded symbols corresponding to the same symbol with each other.

9. A receiver, comprising:
means for receiving a signal transmitted using space time block coding transmit diversity;
means for converting the signal into a digital form;
means for obtaining digital coded symbols from the signal;
first storing means for storing the received coded symbols;
processing means for reading a number of coded symbols from the first storing means and for performing complex instructions belonging to the instruction set of the processing means on the complex coded symbols, the number of the instructions being at most equal to the number of coded symbols, thus obtaining decoded symbols as results of the instructions; and
second storing means for storing the decoded symbols.

10. A receiver, comprising:
means for receiving a signal transmitted using space time block coding transmit diversity;
means for converting the signal into a digital form;
means for obtaining digital coded symbols from the signal, the symbols consisting of a real factor and an imaginary factor;
first storing means for storing the received coded symbols;
processing means for reading a number of coded symbols from the first storing means and for performing complex instructions belonging to the instruction set of the processing means on the complex coded symbols, the number of the instructions being at most equal to the total number of factors in the given number of coded symbols, thus obtaining decoded symbols as results of the instructions; and
second storing means for storing the decoded symbols.

11. An arrangement, arrangement to decode a signal coded with a space time block code, comprising:
a first memory configured to store coded symbols, the symbols consisting of a real factor and an imaginary factor;
a second memory configured to store decoded symbols;
a processor connected to the first and second memory and configured to
read a number of coded symbols from the memory;
perform complex instructions belonging to the instruction set of the decoding processor on the complex coded symbols, the number of the instructions being at most equal to the total number of factors in the given number of coded symbols, thus obtaining decoded symbols as results of the instructions; and to
store the decoded symbols into the second memory.

12. An arrangement to decode a signal coded with a space time block code, comprising:
a first memory configured to store coded symbols;
a second memory configured to store decoded symbols;
a processor connected to the first and second memory and configured to
read a number of coded symbols from the memory;
perform complex instructions belonging to the instruction set of the decoding processor on the complex coded symbols, the number of the instructions being at most equal to the number of coded symbols, thus obtaining decoded symbols as results of the instructions; and to
store the decoded symbols into the second memory.

13. A device to decode a signal coded with a space time block code, comprising:
a first memory configured to store coded symbols;
a second memory configured to store decoded symbols;
a processor connected to the first and second memory and configured to
read a number of coded symbols from the memory;
perform complex instructions belonging to the instruction set of the decoding processor on the complex coded symbols, the number of the instructions being at most equal to the number of coded symbols, thus obtaining decoded symbols as results of the instructions; and to
store the decoded symbols into the second memory.

14. A receiver, comprising:
means for receiving a signal transmitted using a space time block coding transmit diversity;
means for converting the signal into a digital form;
means for obtaining digital coded symbols from the signal;
first storing means for storing the received coded symbols;
processing means for reading a number of coded symbols from the first storing means and for performing complex instructions belonging to the instruction set of the processing means on the complex coded symbols, each complex instruction producing as a result at least one complex decoded symbol; and
second storing means for storing the decoded symbols.

15. A computer program product encoding a computer program of instructions for executing a computer process for decoding a signal transmitted using a space time block coding transmit diversity, the process comprising:
loading a given number of complex coded symbols to the input of a decoding processor;
performing complex instructions belonging to the instruction set of the decoding processor on the complex coded symbols, the number of the instructions being at most equal to the number of coded symbols, thus obtaining decoded symbols as results of the instructions at the output of the decoding processor.
